(19) United States
(12) Patent Application Publication
(10) Pub. No.: US 2023/0224945 A1
(43) Pub. Date: Jul. 13, 2023

(54) INTER-BASE-STATION INTERFERENCE REFERENCE SIGNAL TRANSMISSION AND RECEPTION TIMING

(71) Applicant: QUALCOMM Incorporated, San Diego, CA (US)

(72) Inventors: Yan ZHOU, San Diego, CA (US); Qian ZHANG, Basking Ridge, NJ (US); Navid ABEDINI, Basking Ridge, NJ (US); Tao LUO, San Diego, CA (US); Junyi LI, Fairless Hills, PA (US)

(21) Appl. No.: 17/571,097

(22) Filed: Jan. 7, 2022

(51) Int. Cl. H04W 72/12

(52) U.S. Cl. CPC H04W 72/1231

(57) ABSTRACT

Various aspects of the present disclosure generally relate to wireless communication. In some aspects, a base station may receive, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource. The base station may perform a crosslink interference (CLI) measurement using the reference signal. Numerous other aspects are described.

### FIELD OF THE DISCLOSURE

Aspects of the present disclosure generally relate to wireless communication and to techniques and apparatuses for inter-base-station interference reference signal transmission and reception timing.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a base station. The method may include receiving, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource. The method may include performing a crosslink interference (CLI) measurement using the reference signal.

Some aspects described herein relate to a method of wireless communication performed by a base station. The method may include receiving, in a first time resource and from another base station, a reference signal associated with a second time resource, wherein the first time resource is based at least in part a scheduled uplink reception period associated with the base station, and wherein the second time resource is based at least in part on an adjustment of a scheduled downlink transmission period associated with the other base station such that the reference signal associated with the second time resource is received by the base station within the first time resource. The method may include performing a CLI measurement using the reference signal.

Some aspects described herein relate to a method of wireless communication performed by a base station. The method may include receiving, in a first time resource and from another base station, a reference signal associated with a second time resource, wherein the first time resource is based at least in part on a scheduled uplink reception period associated with the base station, and wherein the second time resource is based at least in part on a scheduled downlink transmission period associated with the other base station. The method may include performing a CLI measurement using the reference signal.

Some aspects described herein relate to an apparatus for wireless communication at a base station. The apparatus may include a memory and one or more processors coupled to the memory. The one or more processors may be configured to receive, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource. The one or more processors may be configured to perform a CLI measurement using the reference signal.

Some aspects described herein relate to an apparatus for wireless communication at a base station. The apparatus may include a memory and one or more processors coupled to the memory. The one or more processors may be configured to receive, in a first time resource and from another base station, a reference signal associated with a second time resource, wherein the first time resource is based at least in part a scheduled uplink reception period associated with the base station, and wherein the second time resource is based at least in part on an adjustment of a scheduled downlink transmission period associated with the other base station such that the reference signal associated with the second time resource is received by the base station within the first time resource. The one or more processors may be configured to perform a CLI measurement using the reference signal.

Some aspects described herein relate to an apparatus for wireless communication at a base station. The apparatus may include a memory and one or more processors coupled to the memory. The one or more processors may be configured to receive, in a first time resource and from another base station, a reference signal associated with a second time resource, wherein the first time resource is based at least in part on a scheduled uplink reception period associated with the base station, and wherein the second time resource is based at least in part on a scheduled downlink transmission period associated with the other base station. The one or more processors may be configured to perform a CLI measurement using the reference signal.

Some aspects described herein relate to a non-transitory computer-readable medium that stores a set of instructions for wireless communication by a base station. The set of instructions, when executed by one or more processors of the base station, may cause the base station to receive, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource. The set of instructions, when executed by one or more processors of the base station, may cause the base station to perform a CLI measurement using the reference signal.

Some aspects described herein relate to a non-transitory computer-readable medium that stores a set of instructions for wireless communication by a base station. The set of instructions, when executed by one or more processors of the base station, may cause the base station to receive, in a first time resource and from another base station, a reference signal associated with a second time resource, wherein the first time resource is based at least in part a scheduled uplink reception period associated with the base station, and wherein the second time resource is based at least in part on an adjustment of a scheduled downlink transmission period associated with the other base station such that the reference signal associated with the second time resource is received by the base station within the first time resource. The set of instructions, when executed by one or more processors of the base station, may cause the base station to perform a CLI measurement using the reference signal.

Some aspects described herein relate to a non-transitory computer-readable medium that stores a set of instructions for wireless communication by a base station. The set of instructions, when executed by one or more processors of the base station, may cause the base station to receive, in a first time resource and from another base station, a reference signal associated with a second time resource, wherein the first time resource is based at least in part on a scheduled uplink reception period associated with the base station, and wherein the second time resource is based at least in part on a scheduled downlink transmission period associated with the other base station. The set of instructions, when executed by one or more processors of the base station, may cause the base station to perform a CLI measurement using the reference signal.

Some aspects described herein relate to an apparatus for wireless communication. The apparatus may include means for receiving, in a first time resource and from a base station, a reference signal associated with a second time resource, wherein the second time resource is based at least in part on a scheduled downlink transmission period associated with the base station, and wherein the first time resource is based at least in part on an adjustment of a scheduled uplink reception period associated with the apparatus such that the reference signal associated with the second time resource is received by the apparatus within the first time resource. The apparatus may include means for performing a CLI measurement using the reference signal.

Some aspects described herein relate to an apparatus for wireless communication. The apparatus may include means for receiving, in a first time resource and from a base station, a reference signal associated with a second time resource, wherein the first time resource is based at least in part a scheduled uplink reception period associated with the apparatus, and wherein the second time resource is based at least in part on an adjustment of a scheduled downlink transmission period associated with the base station such that the reference signal associated with the second time resource is received by the apparatus within the first time resource. The apparatus may include means for performing a CLI measurement using the reference signal.

Some aspects described herein relate to an apparatus for wireless communication. The apparatus may include means for receiving, in a first time resource and a base station, a reference signal associated with a second time resource, wherein the first time resource is based at least in part on a scheduled uplink reception period associated with the apparatus, and wherein the second time resource is based at least in part on a scheduled downlink transmission period associated with the base station. The apparatus may include means for performing a CLI measurement using the reference signal.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3A-3C are diagrams illustrating examples of full duplex communication, in accordance with the present disclosure.

FIGS. 4A-4C is are diagrams illustrating examples of physical channels and reference signals in a wireless network, in accordance with the present disclosure.

FIG. 5 is a diagram illustrating an example 500 associated with inter-base-station interference reference signal transmission and reception timing, in accordance with the present disclosure.

FIGS. 6A-6D are diagrams illustrating examples associated with inter-base-station interference reference signals transmission and reception timing, in accordance with the present disclosure.

FIG. 7 is a diagram illustrating an example process performed, for example, by a base station, in accordance with the present disclosure.

FIG. 8 is a diagram illustrating an example process performed, for example, by a base station, in accordance with the present disclosure.

FIG. 9 is a diagram illustrating an example process performed, for example, by a base station, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

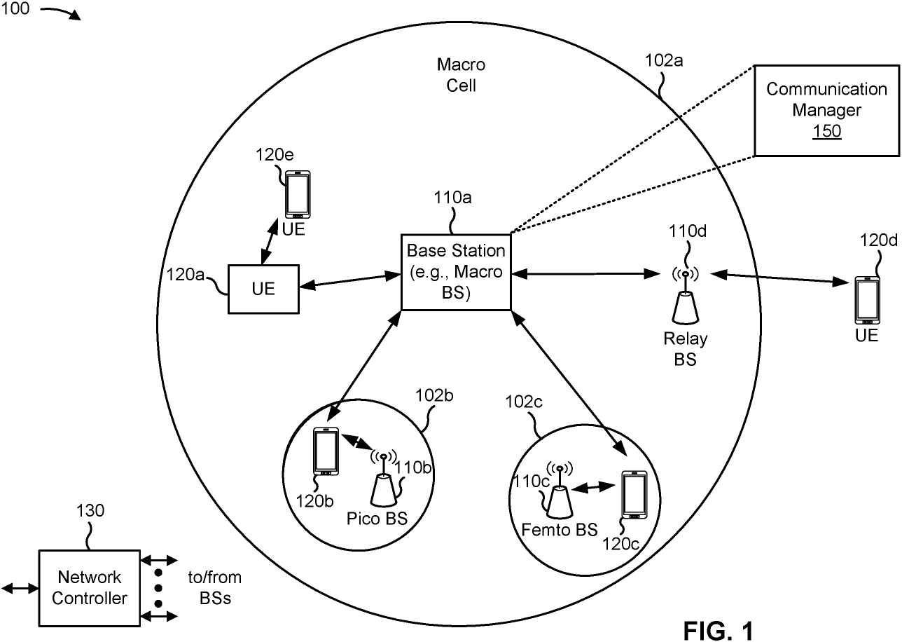

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNodeB (eNB) (e.g., in 4G), a gNodeB (gNB) (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz - 7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz - 114.25 GHz), and FR5 (114.25 GHz - 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the base station 110 may include a communication manager 150. As described in more detail elsewhere herein, the communication manager 150 may receive, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource. The communication manager 150 may perform a crosslink interference (CLI) measurement using the reference signal. Additionally, or alternatively, the communication manager 150 may perform one or more other operations described herein.

In some aspects, the communication manager 150 may receive, in a first time resource and from another base station, a reference signal associated with a second time resource, wherein the first time resource is based at least in part a scheduled uplink reception period associated with the base station, and wherein the second time resource is based at least in part on an adjustment of a scheduled downlink transmission period associated with the other base station such that the reference signal associated with the second time resource is received by the base station within the first time resource. The communication manager 150 may perform a CLI measurement using the reference signal. Additionally, or alternatively, the communication manager 150 may perform one or more other operations described herein.

In some aspects, the communication manager 150 may receive, in a first time resource and from another base station, a reference signal associated with a second time resource, wherein the first time resource is based at least in part on a scheduled uplink reception period associated with the base station, and wherein the second time resource is based at least in part on a scheduled downlink transmission period associated with the other base station. The communication manager 150 may perform a CLI measurement using the reference signal. Additionally, or alternatively, the communication manager 150 may perform one or more other operations described herein.

As indicated above, FIG. 1 is provided as an example. Other examples may differ from what is described with regard to FIG. 1.

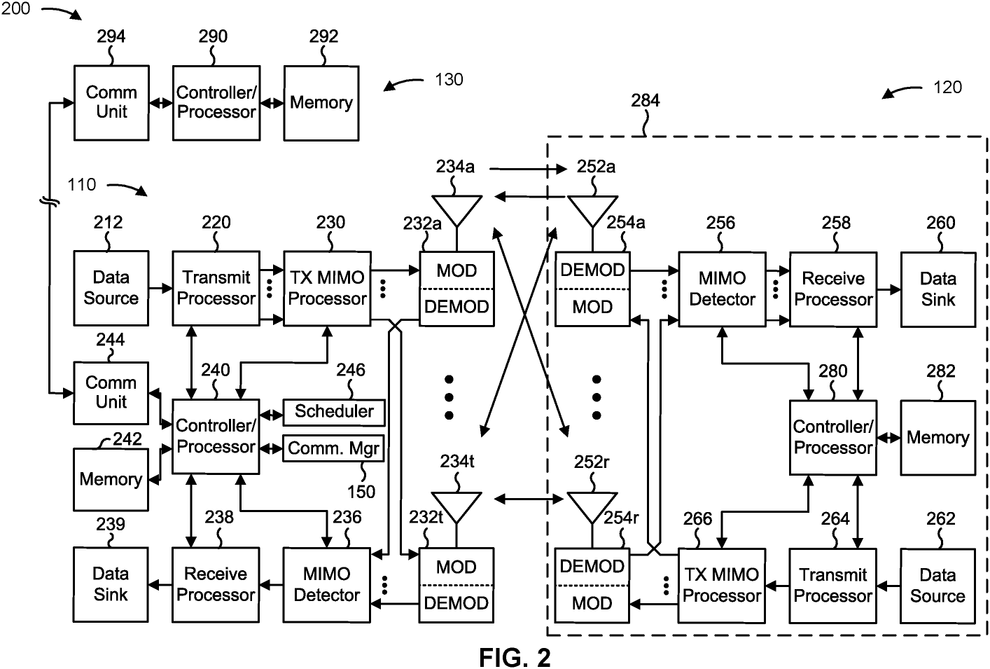

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T ≥ 1). The UE 120 may be equipped with a set of antennas 252a through 252r, such as R antennas (R ≥ 1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

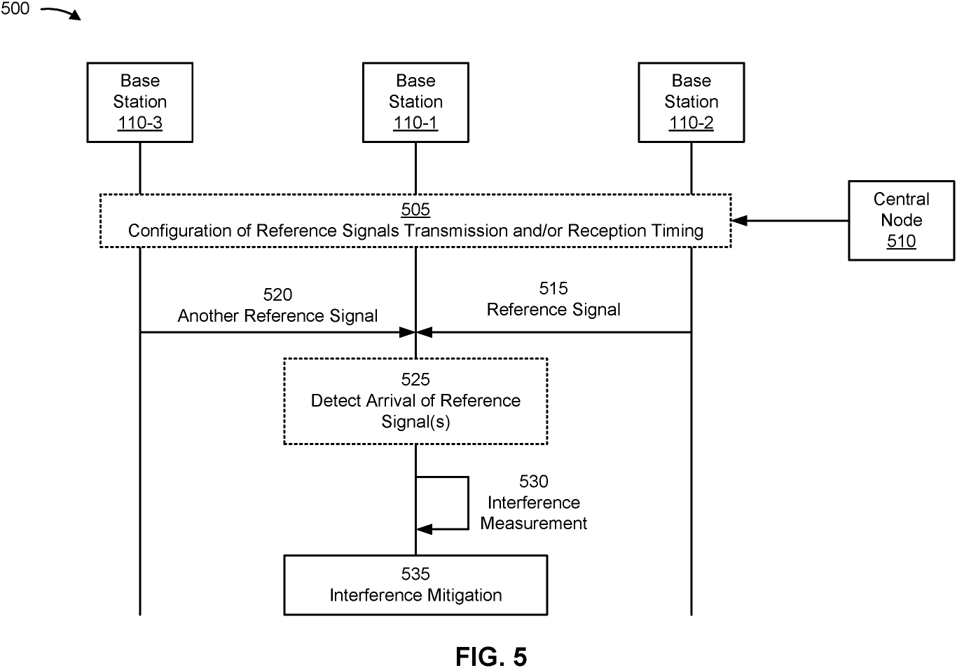

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

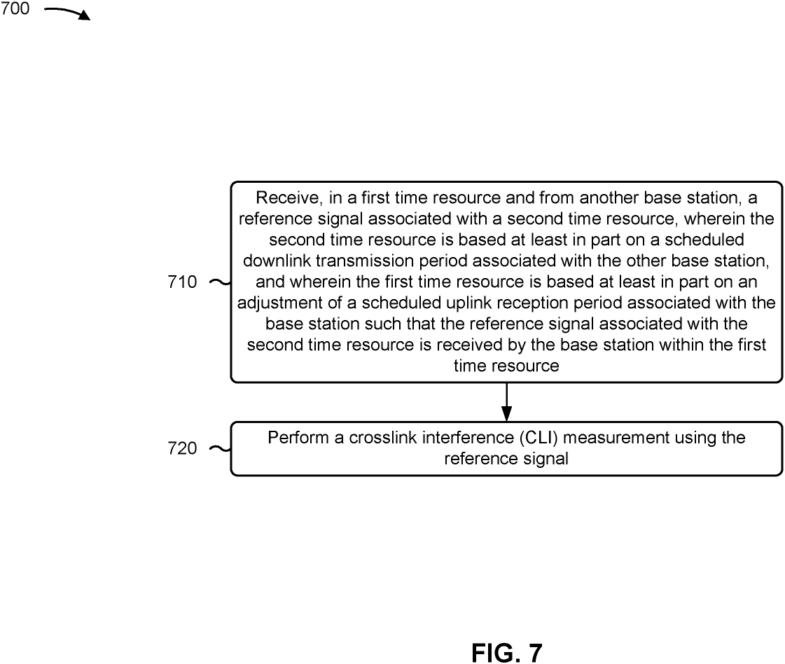

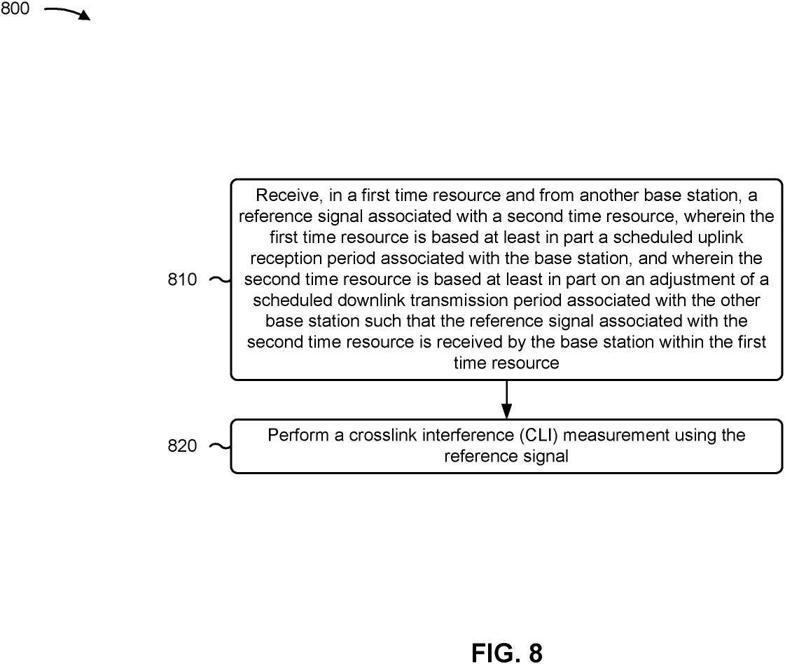

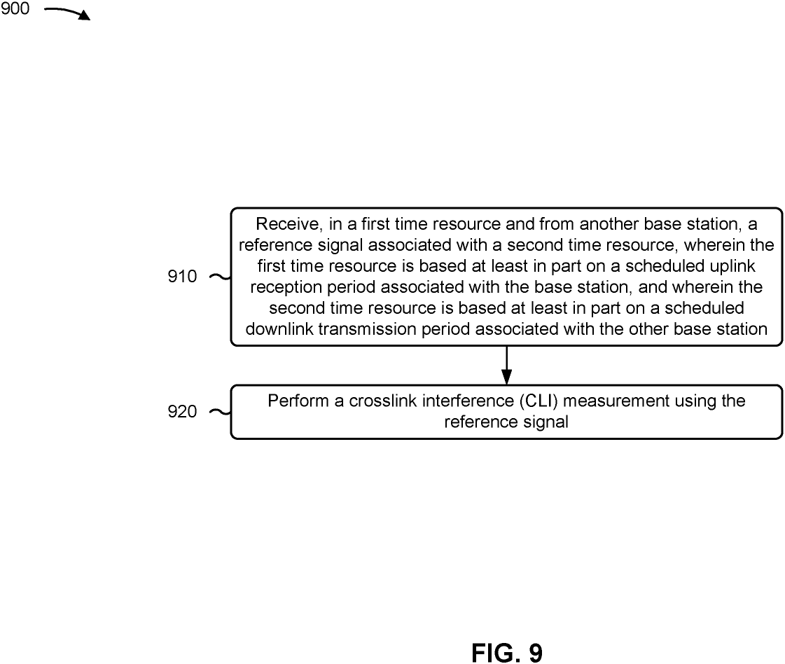

The controller/processor 240 of the base station 110, the controller/processor 280 of the UE 120, and/or any other component(s) of FIG. 2 may perform one or more techniques associated with inter-base-station interference reference signal transmission and reception timing, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the base station includes means for receiving, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource; and/or means for performing a CLI measurement using the reference signal. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the base station includes means for receiving, in a first time resource and from another base station, a reference signal associated with a second time resource, wherein the first time resource is based at least in part a scheduled uplink reception period associated with the base station, and wherein the second time resource is based at least in part on an adjustment of a scheduled downlink transmission period associated with the other base station such that the reference signal associated with the second time resource is received by the base station within the first time resource; and/or means for performing a CLI measurement using the reference signal. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the base station includes means for receiving, in a first time resource and from another base station, a reference signal associated with a second time resource, wherein the first time resource is based at least in part on a scheduled uplink reception period associated with the base station, and wherein the second time resource is based at least in part on a scheduled downlink transmission period associated with the other base station; and/or means for performing CLI measurement using the reference signal. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

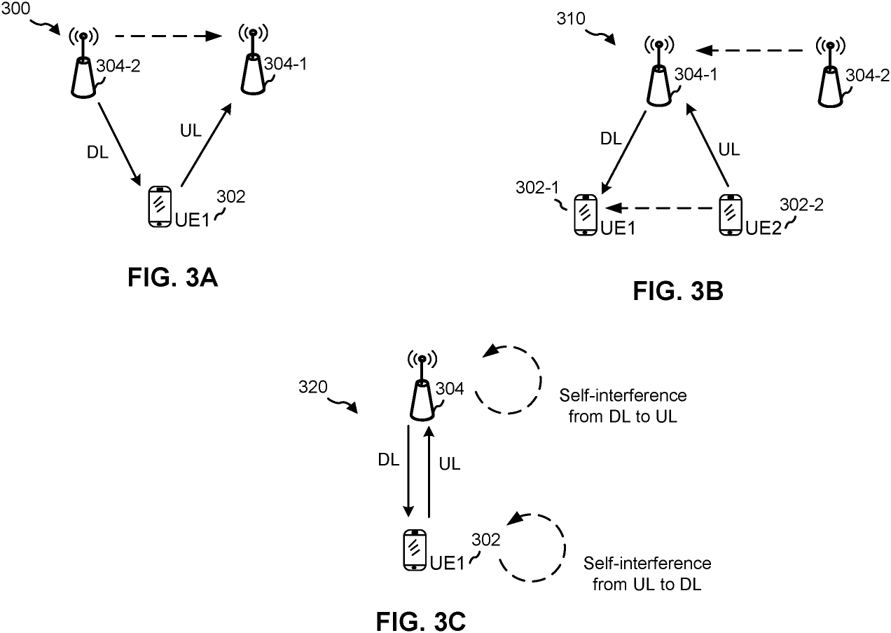

FIGS. 3A-3C are diagrams illustrating examples 300, 310, 320 of full duplex (FD) communication in accordance with the present disclosure. An FD communication is a communication that utilizes overlapped time resources at a single node (such as a UE or a base station) for transmission and reception. For example, a UE or a base station may perform a transmission and a reception using the same time resources, such as via frequency division multiplexing (FDM) or spatial division multiplexing (SDM). “FDM” refers to performing two or more communications using different frequency resource allocations. “SDM” refers to performing two or more communications using different spatial parameters, such as different transmission configuration indicator (TCI) states corresponding to beams. An SDM communication can use overlapped time resources and frequency resources, and an FDM communication can use overlapped time resources and spatial resources (that is, overlapped beam parameters, TCI states, or the like). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasicolocation (QCL) type. A QCL type may indicate one or more spatial parameters to be derived from the source signal. The source signal may be referred to as a QCL source. FD communications can include dynamic traffic (such as scheduled by downlink control information (DCI)) and/or semi-static traffic. Semi-static traffic is traffic associated with a semi-persistent resource, such as a semi-persistent scheduling (SPS) configured resource or a configured grant (CG).

The example 300 of FIG. 3A includes a UE1 302 and two base stations (e.g., TRPs) 304-1, 304-2, wherein the UE1 302 is sending uplink transmissions to base station 304-1 and is receiving downlink transmissions from base station 304-2. In the example 300 of FIG. 3A, FD is enabled for the UE1 302, but not for the base stations 304-1, 304-2. Thus, the base stations 304-1 and 304-2 are half duplex (HD) base stations.

The example 310 of FIG. 3B includes two UEs, UE1 302-1 and UE2 302-2, and a base station 304-1, wherein the UE1 302-1 is receiving a downlink transmission from the base station 304 and the UE2 302-2 is transmitting an uplink transmission to the base station 304-1. In the example 310 of FIG. 3B, FD is enabled for the base station 304-1, but not for the UE1 302-1 and UE2 302-2. Thus, the UE1 302-1 and UE2 302-2 are half duplex UEs. The example 310 of FIG. 3B also includes another base station 304-2, which may cause interference to the FD base station 304-1, described in more detail below.

The example 320 of FIG. 3C includes a UE1 302 and a base station 304, wherein the UE1 302 is receiving a downlink transmission from the base station 304 and the UE1 302 is transmitting an uplink transmission to the base station 304. In the example 320 of FIG. 3C, FD is enabled for both the UE1 302 and the base station 304. In the example 320 of FIG. 3C, the UE1 302 and the base station 304 communicate using a beam pair. A beam pair may include a downlink beam and an uplink beam. For example, a UE1 302 may use a beam pair that includes a downlink beam (that is, a receive beam) at the UE1 302 and an uplink beam (that is, a transmit beam) at the UE1 302 to communicate with the base station 304. The base station 304 may use a downlink beam (that is, a transmit beam) at the base station 304 to transmit communications received via the UE1 302′s downlink beam, and may use an uplink beam (that is, a receive beam) at the base station 304 to receive communications transmitted via the UE1 302′s uplink beam.

In FIGS. 3A-3C, interference is indicated by dashed lines. Interference can occur between nodes of examples 300, 310, 320 (referred to as “crosslink interference” (CLI)). Examples of CLI are shown in FIGS. 3A and 3B. In FIG. 3A, base station 304-2′s downlink transmission interferes with base station 304-1′s uplink transmission. In FIG. 3B, UE1 302-1′s uplink transmission interferes with UE2 302-2′s downlink transmission, and a downlink transmission of base station 304-2 interferes with base station 304-1′s uplink transmission. In some cases, self-interference can occur. Self-interference occurs when a node’s transmission interferes with a reception operation of the node. For example, self-interference may occur due to reception by a receive antenna of radiated energy from a transmit antenna, cross-talk between components, or the like. Examples of self-interference at a UE 302 (from an uplink transmission to a downlink reception) and at a base station 304 (from a downlink transmission to an uplink reception) are shown in FIG. 3C. It should be noted that the above-described CLI and self-interference conditions can occur in HD deployments and in FD deployments.

As indicated above, FIGS. 3A-3C are provided as one or more examples. Other examples may differ from what is described with regard to FIGS. 3A-3C.

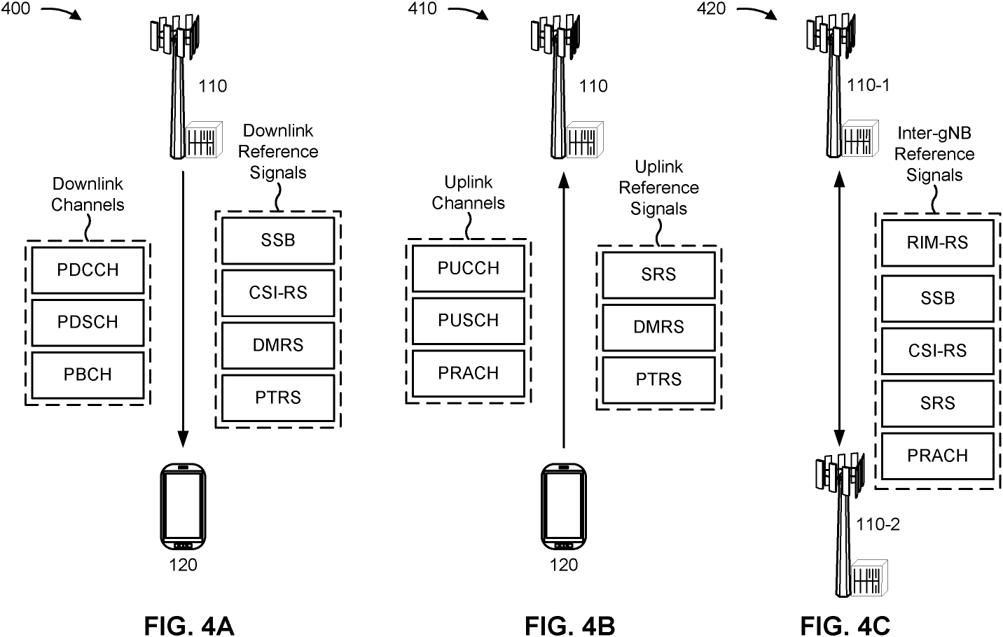

FIGS. 4A-4C are diagrams illustrating examples 400, 410, 420 of physical channels and reference signals in a wireless network, in accordance with the present disclosure. As shown in FIGS. 4A-4C, downlink channels and downlink reference signals may carry information from a base station 110 to a UE 120, uplink channels and uplink reference signals may carry information from a UE 120 to a base station 110, and one or more reference signals may be communicated between two or more base stations 110-1, 110-2.

As shown in the example 400 of FIG. 4A, a downlink channel may include a physical downlink control channel (PDCCH) that carries DCI, a physical downlink shared channel (PDSCH) that carries downlink data, or a physical broadcast channel (PBCH) that carries system information, among other examples. In some aspects, PDSCH communications may be scheduled by PDCCH communications. As further shown in the example 410 of FIG. 4B, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown in the example 400 of FIG. 4A, a downlink reference signal may include a synchronization signal block (SSB), a channel state information (CSI) reference signal (CSI-RS), a DMRS, a positioning reference signal (PRS), or a phase tracking reference signal (PTRS), among other examples. As shown in the example 410 of FIG. 4B, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

In some aspects, one or more reference signals may be transmitted between two base stations 110-1 and 110-2, as shown by the example 420 of FIG. 4C. For example, during certain atmospheric conditions, downlink transmissions by one base station (e.g., the base station 110-2) may travel long distances and interfere with the uplink reception of another base station (e.g., base station 110-1), sometimes referred to as remote interference (RI). In some cases, RI is caused by an atmospheric ducting effect, during which layering of the air may form a waveguide (e.g., a duct) that may carry radio signals long distances with low propagation losses. Thus, downlink transmissions from one base station (e.g., base station 110-2) may interfere with the uplink communications received at another base station (e.g., base station 110-1) during certain atmospheric conditions. To account for such RI, one or more base stations (e.g., one or more of base stations 110-1 and 110-2) may transmit a remote interference management (RIM) reference signal (RIM-RS) to one or more other base stations when atmospheric ducting is present. The base stations 110-1, 110-2 may then perform one or more measurements using the RIM-RS, and/or the base stations 110-1, 110-2 may account for the RI, such as by switching to another transmit beam experiencing less RI than a current transmit beam or performing a similar mitigation procedure.

In some cases, it may be beneficial to receive an inter-base-station reference signal for purposes of measuring another base station’s interference, even when the atmospheric ducting effect is not present. For example, and as described above in connection with FIG. 3C, a base station 304-1 operating in a FD mode may experience CLI from another base station 304-2. However, base stations (e.g., base station 110-1 and/or base station 110-2) traditionally only transmit an RIM-RS during periods of atmospheric ducting, and thus may not receive an RIM-RS when operating in a FD mode and/or when CLI from another base station is present. Moreover, the RIM framework may not be optimized for reducing interference beyond RI, such as CLI or other types of interference. Thus, the traditional inter-base-station reference signal framework (e.g., the traditional RIM framework) does not support reference signaling for purposes of CLI measurements or the like. As a result, a base station may experience CLI or other interference, resulting in degraded network performance, such as increased latency, dropped calls or other interrupted communications, or link failure.

Some techniques and apparatuses described herein enable reference signaling between two or more base stations, even in the absence of atmospheric ducting that may otherwise trigger the RIM framework, in order to perform one or more interference measurements, such a CLI measurement when a base station is operating in a FD mode. In some aspects, as in the example 420 shown in FIG. 4C, one or more of a RIM-RS, an SSB signal, a CSI-RS, an SRS, and/or a PRACH signal may be transmitted between two base stations 110-1, 110-2 for purposes of performing a CLI or other interference measurement. Moreover, one or both of the base stations 110-1, 110-2 may alter a scheduled uplink reception period or a downlink transmission period in order to receive or send, respectively, the reference signal. For example, in some aspects, a base station (e.g., base station 110-1) may receive, in a first time resource, a reference signal that was transmitted by another base station (e.g., base station 110-2) using a second time resource. In some aspects, the first time resource may be based at least in part on a scheduled uplink reception period associated with the base station, and the second time resource may be based at least in part on a scheduled downlink transmission period associated with the other base station. In some other aspects, the first time resource may be based at least in part on an arrival time of the reference signal and/or on the scheduled downlink transmission period associated with the other base station. And in some other aspects, the second time resource may be based at least in part on the scheduled uplink reception period associated with the base station. Additionally, or alternatively, in some aspects, the first time resource and/or the second time resource may be configured by a central node or defined according to a wireless communication specification. As a result, the base stations may share one or more reference signals, enabling one or more of the base stations to perform interference measurements (e.g., CLI measurements) and interference mitigation techniques, resulting in increased network performance, such as reduced latency, increased throughput, reduced link failure, and otherwise uninterrupted communications.

As indicated above, FIG. 4 is provided as an example. Other examples may differ from what is described with regard to FIG. 4.

FIG. 5 is a diagram illustrating an example 500 associated with inter-base-station interference reference signal transmission and reception timing, in accordance with the present disclosure.

As shown in FIG. 5, two or more base stations 110 may communicate with one another using a wireless network (e.g., wireless network 100). For example, a first base station 110-1 may communicate with a second base station 110-2 and/or a third base station 110-3. In some aspects, one or more of the base stations (e.g., base station 110-1) may be operating in a FD mode with two or more UEs (such as described above in connection with the base station 304-1 of example 310 in FIG. 3B), and one or more of the other base stations (e.g., base stations 110-2 and 110-3) may be causing CLI with respect the base station operating in the FD mode. In some other aspects, one or more of the base stations (e.g., base station 110-1) may be operating in a HD mode with a UE (such as described above in connection with the base station 304-1 or 304-2 of example 300 in FIG. 3A), and one or more of the other base stations (e.g., base stations 110-2 and 110-3) may be causing CLI with respect to an uplink communication at the HD base station. Moreover, in some aspects, one or more of the first base station 110-1, the second base station 110-2, or the third base station 110-3 may be receive a reference signal from one or more of the other base stations. In such aspects, the one or more base stations receiving the one or more reference signals (e.g., the first base station 110-1 in FIG. 5) may sometimes be referred to as a receiver base station or a receiver gNB, and the one or more base stations transmitting the one or more reference signals (e.g., the second base station 110-2 and the third base station 110-3 in FIG. 5) may sometimes referred as a transmitter base station or a transmitter gNB.

As shown by reference number 505, in some aspects, the base stations 110-1, 110-2, 110-3 may receive a configuration of reference signals transmission and/or reception timing. The configuration of reference signals transmission and/or reception timing may indicate a set of time and/or frequency resources for each of the base stations 110-1, 110-2, 110-3 to transmit and/or receive one or more inter-base-station reference signals. For example, the configuration of reference signals transmission and/or reception timing may configure a first time resource for the first base station 110-1 to receive one more inter-base-station reference signals, sometimes referred to herein as a reception window. Additionally, or alternatively, the configuration of reference signal transmission and/or reception timing may configure a second time resource for the second base station 110-2 to transmit one or more inter-base-station reference signals and/or a third time resource for the third base station 110-2 to transmit one or more inter-base-station reference signals, sometimes referred to herein as transmission windows.

In some aspects, the configuration of reference signals transmission and/or reception timing may be transmitted to each base station 110-1, 110-2, 110-3 by a central node 510, such as an operation and management (OAM) node, a location management function (LMF) node, a gNB central unit (gNB-CU) node, and/or a gNB distributed unit (gNB-DU) node. Additionally, or alternatively, in some embodiments one or base stations 110-1, 110-2, 110-3 may transmit the configuration of reference signals transmission and/or reception timing to the other of the base stations 110-1, 110-2, 110-3.

In some other aspects, the configuration of reference signals transmission and/or reception timing shown by reference number 505 may be omitted. In such aspects, the reference signals transmission and/or reception timing schemes described herein may be otherwise provided to one or more of the base stations 110-1, 110-2, 110-3. For example, in some aspects, the reference signals transmission and/or reception timing schemes described herein may be defined in a wireless communication specification, such as a specification promulgated by the 3GPP or a similar specification. Additionally, or alternatively, the one or more of the reference signals transmission and/or reception timing schemes described herein may be hard coded for each of the base stations 110-1, 110-2, 110-3, and thus the techniques described herein may be implemented without separately receiving the configuration of reference signal transmission and/or reception timing shown by reference number 505.

As shown by reference numbers 515 and 520, the base stations 110-1, 110-2, 110-3 may exchange one or more reference signals. For example, the first base station 110-1 may receive a reference signal from the second base station 110-2 (as shown by reference number 515), and/or the first base station 110-1 may receive another reference signal from the third base station 110-3 (as shown by reference number 520). The reference signal shown by reference number 515 and/or the other reference signal shown by reference number 520 may be one or more of the reference signals described above in connection with FIG. 4C, such as one or more of an RIM-RS, an SSB signal, a CSI-RS, an SRS, and/or a PRACH signal. The reference signal shown by reference number 515 and/or the other reference signal shown by reference number 520 may be transmitted and/or received according to a timing scheme as indicated by the configuration of reference signal transmission and/or reception timing shown by reference number 505, according to a timing scheme defined by a wireless communication specification and/or hard coded at the base stations 110-1, 110-2, 110-3, or according to a timing scheme otherwise indicated to the base stations 110-1, 110-2, 110-3. For example, in some embodiments the first base station 110-1 may receive the reference signal and/or the other reference signal in a first time resource, the second base station 110-2 may transmit the reference signal using a second time resource, and the third base station 110-3 may transmit the other reference signal using a third time resource.

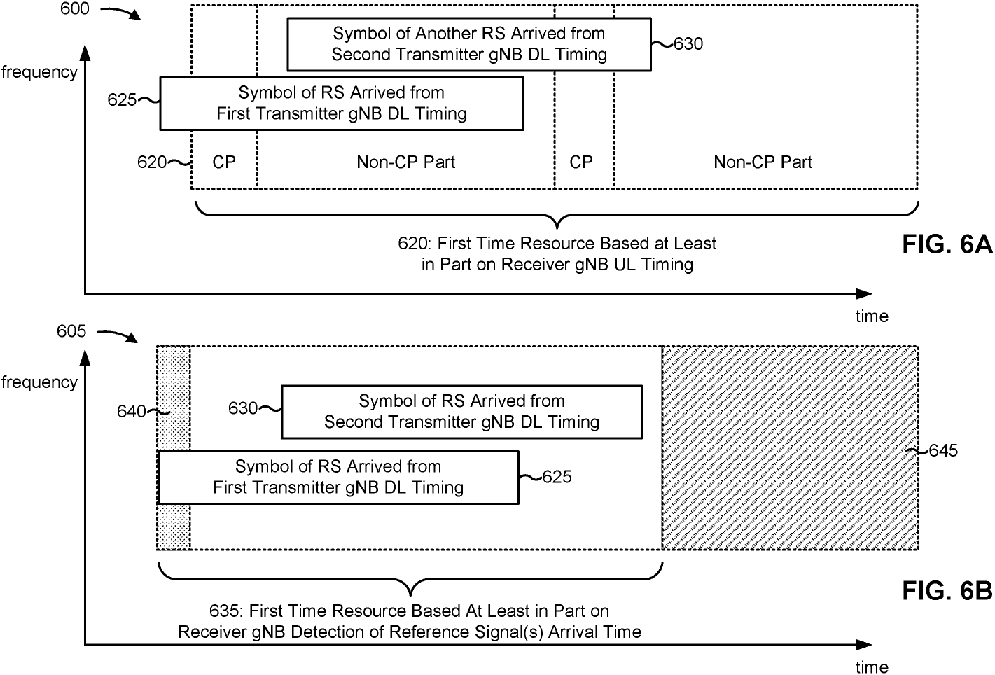

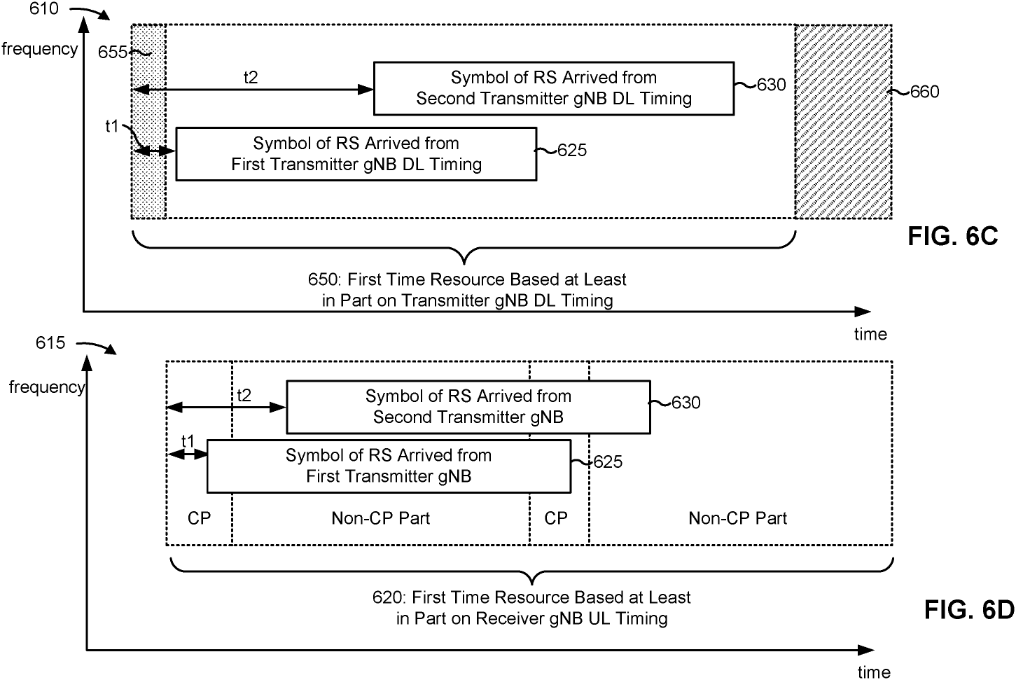

As described more fully in connection with FIGS. 6A-6D, the first time resource may be based at least in part on a scheduled uplink reception period associated with the first base station 110-1, the second time resource may be based at least in part on a scheduled downlink transmission period associated with the second base station 110-2, and/or the third time resource may be based at least in part on a scheduled downlink transmission period associated with the third base station 110-3. For example, in some aspects (described in connection with FIG. 6A below), the first time resource is based at least in part on the scheduled uplink reception period associated with the first base station 110-1, the second time resource is based at least in part on the scheduled downlink transmission period associated with the second base station 110-2, and the third time resource is based at least in part on the scheduled downlink transmission period associated with the third base station 110-3.

In some other aspects (described in connection with FIGS. 6B and 6C, below), the second time resource is based at least in part on the scheduled downlink transmission period associated with the second base station 110-2 and the third time resource is based at least in part on the scheduled downlink transmission period associated with the third base station 110-3, but the first time resource is based at least in part on an adjustment of a scheduled uplink reception period associated with the first base station 110-1 such that the reference signal shown by reference number 515 and/or the other reference signal shown by reference number 520 are received by the first base station 110-1 within the first time resource. In such aspects, the first base station 110-1 may detect the arrival of the reference signal shown by reference number 515 and/or the other reference signal shown by reference number 520, as shown by reference number 525. Additionally, or alternatively, the first base station 110-1 may receive an indication of the second time resource and/or the third time resource and adjust a scheduled uplink reception period associated with the first base station 110-1 based at least in part on the indication.

In some other aspects (described in connection with FIG. 6D below), the first time resource is based at least in part on the scheduled uplink reception period associated with the first base station 110-1, but the second time resource is based at least in part on an adjustment of a scheduled downlink transmission period associated with the second base station 110-2 and/or the third time resource is based at least in part on an adjustment of a scheduled downlink transmission period associated with the third base station 110-3 such that the reference signal shown by reference number 515 and/or the other reference signal shown by reference number 520 are received by the first base station 110-1 within the first time resource. In some aspects, the second base station 110-2 and/or the third base station 110-3 may receive an indication of the first time resource and adjust a scheduled downlink transmission period associated with the second base station 110-2 and the third base station 110-3, respectively, based at least in part on the indication.

As shown by reference number 530, the first base station 110-1 may perform an interference measurement using the reference signal shown by reference number 515 and/or the other reference signal shown by reference number 520. For example, and as described in more detail below in connection with FIGS. 6A-6D, the first base station 110-1 may perform one or both of an RSRP and/or RSSI measurement using the reference signal shown by reference number 515 and/or the other reference signal shown by reference number 520. In some aspects, the first base station 110-1 may be operating in an FD mode, and thus may be receive uplink transmissions from one or more UEs. In such aspects, the first base station 110-1 may perform a CLI measurement (e.g., the first base station 110-1 may measure one or more received reference signals for purposes of determining a CLI with the base station 110-1′s uplink transmissions). In some other aspects, the first base station 110-1 may be operating in a HD mode, and may perform a CLI measurement associated with an uplink transmission from a UE. Moreover, as shown by reference number 535, in some aspects, the first base station 110-1 may perform interference (e.g., CLI) mitigation based at least in part on the measurements performed at the process shown by reference number 530. For example, in aspects in which the CLI is above a CLI threshold, the first base station 110-1 may perform a beam reselection process to select a new beam to be used for uplink receptions to mitigate the inter-base-station CLI (e.g., the base station 110-1 may use a beam for uplink receptions associated with a CLI that is below a CLI threshold).

As indicated above, FIG. 5 is provided as an example. Other examples may differ from what is described with respect to FIG. 5.

FIGS. 6A-6D are diagrams illustrating examples 600, 605, 610, 615 associated with inter-base-station interference reference signals transmission and reception timing, in accordance with the present disclosure. More particularly, each example 600, 605, 610, 615 illustrates a timing scheme that may be utilized by the base stations 110-1, 110-2, 110-3 for transmitting and/or receiving inter-base-station reference signals, such as one or more of the reference signals described above in connection with FIG. 4C. The timing schemes depicted in FIGS. 6A-6D may be defined by a wireless communication specification and/or hard coded at the base stations 110-1, 110-2, 110-3, may be indicated by a configuration provided by a central node 510 or the like (as indicated by reference number 505 in FIG. 5), or may be otherwise indicated to the base stations 110-1, 110-2, 110-3.

In the example 600 shown in FIG. 6A, a base station receiving one or more reference signals (e.g., a receiver base station, such as the first base station 110-1) utilizes a scheduled uplink reception period to receive any reference signals, while the base stations transmitting the one or more reference signals (e.g., transmitter base stations, such as the second base station 110-2 or the third base station 110-3) utilize a respective scheduled downlink transmission period to transmit any reference signals. In such aspects, the first time resource may be based at least in part on the scheduled uplink reception period associated with the receiver base station, the second time resource may be based at least in part on the scheduled downlink transmission period associated with a first transmitter base station, and/or the third time resource may be based at least in part on a scheduled downlink transmission period associated with the second transmitter base station.

More particularly, the example 600 shown in FIG. 6A shows a first time resource 620 (e.g., a reception window) associated with a receiver base station (e.g., the first base station 110-1). The first time resource 620 may be associated with one or more symbols (in the depicted example, two symbols) scheduled for uplink reception by the receiver base station (e.g., scheduled for use by a UE to transmit a communication to the receiver). The symbols of the first time resource 620 may include a CP part and a non-CP part. The receiver base station may receive one or more reference signals from the other base stations, as described in connection with reference numbers 515 and 520. More particularly, in this example, a first transmitter base station (e.g., the second base station 110-2) and a second transmitter base station (e.g., the third base station 110-3) may transmit a corresponding reference signal using a second and a third time resource, respectively. The second and the third time resource correspond to the transmitter base stations’ scheduled downlink transmission periods (e.g., the second time resource corresponds to a scheduled downlink transmission period associated with the first transmitter base station, and the third time resource corresponds to a scheduled downlink transmission period associated with the second transmitter base station).

Due to various factors such as a distance between the respective base stations, wave propagation, atmospheric conditions, or the like, the reference signals transmitted from each transmitter base station may arrive at the receiver base station at different times. For example, in FIG. 6A a symbol of a reference signal 625 associated with the first transmitter base station arrives at the receiver base station prior to a symbol of another reference signal 630 associated with the second transmitter base station. Moreover, a portion of the symbol of the reference signal 625 associated with the first transmitter base station and/or a portion of the symbol of the other reference signal 630 associated with the second transmitter base station may overlap with the first time resource 620, as shown. In this regard, the receiver base station may receive the portions of the symbols of the one or more reference signals within the first time resource 620 and perform an interference measurement accordingly. In some aspects, the reference signal and/or the other reference signal may be one of RIM-RS, an SSB signal, a CSI-RS, an SRS, and/or a PRACH signal, and the interference measurement may be one associated with a CLI when the receiver base station is operating in a FD mode.

In some aspects, the symbol of the reference signal 625 associated with the first transmitter base station and/or the symbol of the other reference signal 630 associated with the second transmitter base station may not be fully encompassed in the first time resource 620. Accordingly, in some aspects, the receiver base station may perform interference measurements that do not require coherent demodulation of the reference signals and/or that do not require reception of the entire symbol of the reference signal 625 associated with the first transmitter base station and/or the entire symbol of the other reference signal 630 associated with the second transmitter base station. For example, the receiver base station may perform an RSSI measurement, which measures the relative power of the received signal but does not require coherent demodulation (and thus may be performed even when only a partial symbol of the reference signal is received in the first time resource 620). Moreover, in some aspects, the reference signals may be frequency division multiplexed such that the receiver base station may distinguish reference signals received from different transmitter base stations. In the example 600 shown in FIG. 6A, the reference signal is transmitted using a lower frequency band than the other reference signal, such that the receiver base station (e.g., the first base station 110-1) can distinguish between the two reference signals.

In some aspects, one or more of the base stations may adjust their respective uplink reception periods and/or downlink transmission periods to coordinate the transmission and reception of reference signals with other base stations. For example, in the examples 605 and 610 shown in FIG. 6B and FIG. 6C, respectively, the first and second transmitter base stations (e.g., the second base station 110-2 and the third base station 110-3) may transmit their corresponding reference signals using their respective scheduled downlink transmission periods (e.g., the first and second transmitter base stations may transmit their respective reference signals using the same time resources described in connection with FIG. 6A), and thus the symbol of the reference signal 625 associated with the first transmitter base station and the symbol of the other reference signal 630 associated with the second transmitter base station may arrive at the receiver base station (e.g., the first base station 110-1) in a similar fashion as described above. However, in this aspect, the first time resource may be based at least in part on an adjustment of the receiver base station’s scheduled uplink reception period such that the reference signal and/or the other reference signal are received by the receiver base station within the first time resource.

More particularly, in the example 605 shown in FIG. 6B, the receiver base station detects an arrival of one or more reference signals, as described above in connection with reference number 525, and adjusts and/or configures a first time resource 635 to coincide with the arrival of the one or more reference signals. For example, the receiver base station may detect the arrival of the symbol of the reference signal 625 associated with the first transmitter base station, and thus begins to receive the reference signal accordingly. Thus, in this aspect, the beginning of the first time resource 635 is associated with the arrival of the symbol of the reference signal 625 associated with the first transmitter base station. Moreover, the receiver base station may detect additional reference signals and thus adjust and/or otherwise configure the first time resource 635 to continue to receive the reference signals, even after the receiver base station has fully received the symbol of the reference signal 625 associated with the first transmitter base station. For example, the receiver base station may additionally detect the arrival of the symbol of the other reference signal 630 associated with the second transmitter base station, and may adjust and/or configure the first time resource 635 to encompass the symbol of the other reference signal 630 associated with the second transmitter base station (e.g., the receiver base station may continue to receive reference signals until the receiver base station no longer detects an incoming reference signal). In some aspects, configuring the first time resource 635 in the manner described in connection with FIG. 6B may result in an adjustment of a scheduled uplink reception period associated with the receiver base station. More particularly, as compared to the first time resource 620 described in connection with FIG. 6A, the first time resource 635 includes a first portion 640 that precedes the scheduled uplink reception period (e.g., the first time resource 620 shown in FIG. 6A), and the first time resource 635 excludes a second portion 645 that forms part of the scheduled uplink reception period.

In the example 610 shown in FIG. 6C, rather than detecting the arrival of the reference signals as in the example 605 of FIG. 6B, the receiver base station (e.g., the first base station 110-1) may receive an indication of the scheduled downlink transmission periods associated with the transmitter base stations (e.g., the second base station 110-2 and/or the third base station 110-3), and thus adjust the receiver base station’s scheduled uplink reception period based at least in part on the indication. In some aspects, the receiver base station may receive the indication from a central network node, such as the central node 510, while in some other aspects the receiver base station may receive the indication from one or more other base stations (e.g., one or more of the transmitter base stations). The receiver base station may adjust or otherwise configure a first time resource 650 (e.g., a reception window) so that one or more of the reference signals are received within the first time resource 650. More particularly, in the depicted example 610, the receiver base station adjusts the first time resource 650 such that the symbol of the reference signal 625 associated with the first transmitter base station and the symbol of the other reference signal 630 associated with the second transmitter base station are received within the first time resource 650. In some aspects, configuring the first time resource 650 in the manner described in connection with FIG. 6C may result in an adjustment of a scheduled uplink reception period associated with the receiver base station. More particularly, the first time resource 650 includes a first portion 655 that precedes the scheduled uplink reception period (e.g., the first time resource 620 shown in FIG. 6A), and the first time resource 650 excludes a second portion 660 that forms part of the scheduled uplink reception period.

When the first time resource encompasses the symbols of the reference signals, such as is shown in the examples 605 and 610 in FIG. 6B and FIG. 6C, respectively, the receiver base station (e.g., the first base station 110-1) may perform signal measurements that require coherent demodulation of the reference signal, because the symbol of the reference signal 625 and/or the symbol of the other reference signal 630 may be completely received by the receiver base station and thus may be coherently decoded. For example, in addition to an RSSI measurement (which does not require coherent demodulation), the receiver base station may perform an RSRP measurement (which does require coherent demodulation).

Moreover, in some aspects, the first time resource may be configured and/or adjusted such that a difference between a time at which the first time resource begins and a time at which a reference signal arrives at the receiver base station is less than a threshold time period. For example, in the example 610 shown in FIG. 6C, a difference between a time at which the first time resource 650 begins and a time at which the symbol of the reference signal 625 associated with the first transmitter base station arrives at the receiver base station is depicted as t1, and a difference between a time at which the first time resource 650 begins and a time at which the symbol of the other reference signal 630 associated with the second transmitter base station arrives at the receiver base station is depicted as t2. One or both of t1 or t2 may be configured to be less than the threshold time period. In some aspects, the threshold time period may equal to a duration of a CP of a symbol of the first time resource 650. In some other aspects, the threshold time period may equal a duration of a number of symbols (e.g., one symbol) of the first time resource 650. Limiting the time difference between a time at which the first time resource 650 begins and a time at which one or more symbols of the reference signal arrives at the receiver base station may beneficially provide for coherent demodulation of the reference signal, thus enabling RSRP measurements (instead of or in addition to RSSI measurements).

In some aspects, the reference signal received in the examples 605 and 610 shown in FIGS. 6B and 6C, respectively, may be any of the reference signals described above in connection with FIG. 4C, such as one of an RIM-RS, an SSB signal, a CSI-RS, an SRS, and/or a PRACH signal. Moreover, in aspects in which the arrival of the reference signal is detected by the receiver base station, such as described in connection with FIG. 6B, the reference signal and/or the other reference signal may be a type of reference signal specifically configured to be used by a base station notwithstanding that the reference signal is transmitted with an unknown arrival time (e.g., the reference signal and/or the other reference signal may be a signal that is configured to be detected by a receiver base station even without the receiver base station knowing the arrival time in advance). In some aspects, the reference signal and/or the other reference signal may thus be one of an SSB signal, a PRACH signal, or an RIM-RS, which may be configured to be detected by a base station even without a known arrival time.

Moreover, in some aspects, the reference signal and the other reference signal may be frequency division multiplexed, as shown in FIGS. 6B and 6C. However, in other aspects, the reference signals may overlap in the time and/or frequency domain and instead be code division multiplexed. More particularly, because, in these aspects, the first time resource 635, 650 is configured to receive the entire reference signal (e.g., the symbol of the reference signal 625 and the symbol of the other reference signal 630 are encompassed by the first time resource 635, 650), the receiver base station may be capable of distinguishing overlapping, in the time and frequency domain, reference signals if low correlation sequences are used (e.g., if the reference signals are orthogonal to one another).

In some aspects, the second time resource and/or the third time resource (e.g., the second transmission window and/or the third transmission window) may be based at least in part on an adjustment of the respective transmitter base station’s downlink transmission period. For example, in the example 615 shown in FIG. 6D, the receiver base station (e.g., the first base station 110-1) may receive any reference signals using the first time resource 620, as described above in connection with FIG. 6A (e.g., the receiver base station may use time resources based at least in part on the receiver base station’s uplink reception period). In this example, however, the transmitter base stations (e.g., the second base station 110-2 and the third base station 110-3) may adjust when their respective reference signals are transmitted so that the reference signals arrive within the first time resource 620. For example, as shown in FIG. 6A, when the reference signal is transmitted using the first transmitter base station’s scheduled downlink transmission period, the symbol of the reference signal 625 arrives prior to the first time resource 620, and thus the reference symbol cannot be coherently demodulated for purposes of performing an RSRP measurement or similar measurement. In this aspect, however, the second time resource (e.g., the transmission window associated with the second base station 110-2) may be based at least in part on an adjustment of the first transmitter base station’s scheduled downlink transmission period such that the reference signal associated with the second time resource (e.g., the symbol of the reference signal 625 associated with the first transmitter base station) is received by the receiver base station within the first time resource 620. Additionally, or alternatively, the third time resource (e.g., the transmission window associated with the third base station 110-3) may be based at least in part on an adjustment of the second transmitter base station’s scheduled downlink transmission period such that the other reference signal associated with the third time resource (e.g., the symbol of the other reference signal 630 associated with the second transmitter base station) is received by the receiver base station within the first time resource 620. And, in a similar manner as described in connection with FIG. 6C, the second time resource and/or the third time resource may be configured and/or adjusted such that a difference between a time at which the first time resource begins and a time at which a corresponding reference signal arrives at the receiver base station (e.g., t1 and t2, respectively) is less than a threshold time period, which may be a duration of a CP of the first time resource 620, a duration of a threshold number of symbols (e.g., one) of the first time resource 620, or the like.

In some aspects, the reference signal received in the example 615 shown in FIG. 6D may be any of the reference signals described above in connection with FIG. 4C, such as of an RIM-RS, an SSB signal, a CSI-RS, an SRS, and/or a PRACH signal. Moreover, because the first time resource 620 encompasses the symbols of the reference signals, the receiver base station may perform signal measurements that require coherent demodulation of the reference signal, including an RSRP measurement (instead of, or in addition to, an RSSI measurement). Furthermore, in some aspects, the reference signal and the other reference signal may be frequency division multiplexed, as shown in FIG. 6D. However, in other aspects, the reference signals may overlap in the time and/or frequency domain and instead be code division multiplexed, in a similar manner as described above in connection with FIGS. 6B and 6C.

As indicated above, FIGS. 6A-6D are provided as one or more examples. Other examples may differ from what is described with regard to FIGS. 6A-6D.

FIG. 7 is a diagram illustrating an example process 700 performed, for example, by a base station, in accordance with the present disclosure. Example process 700 is an example where the base station (e.g., base station 110-1) performs operations associated with inter-base-station interference reference signal transmission and reception timing.

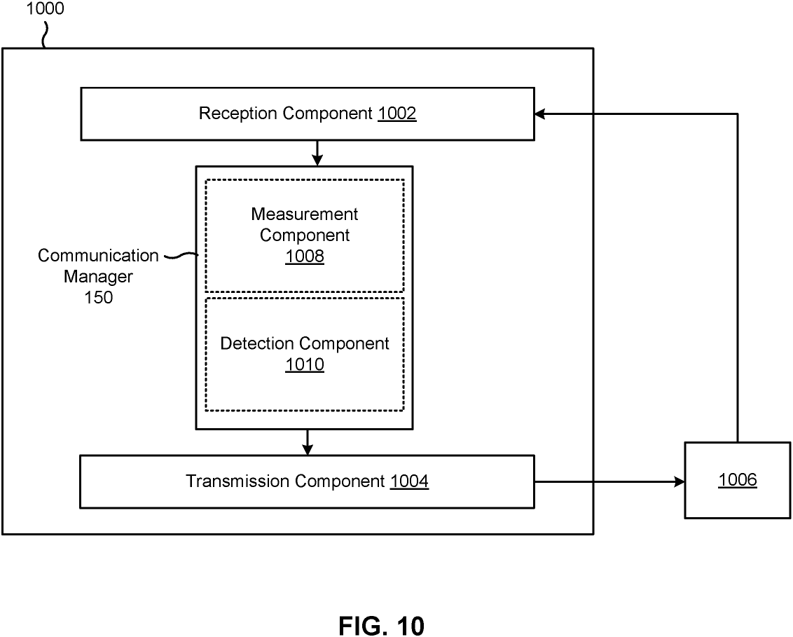

As shown in FIG. 7, in some aspects, process 700 may include receiving, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource (block 710). For example, the base station (e.g., using communication manager 150 and/or reception component 1002, depicted in FIG. 10) may receive, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource, as described above.

As further shown in FIG. 7, in some aspects, process 700 may include performing a CLI measurement using the reference signal (block 720). For example, the base station (e.g., using communication manager 150 and/or measurement component 1008, depicted in FIG. 10) may perform a CLI measurement using the reference signal, as described above.

Process 700 may include additional aspects, such as any single aspect or any combination of aspects described below and/or in connection with one or more other processes described elsewhere herein.

In a first aspect, the base station is operating in a full duplex mode by receiving a first communication from a first UE in an uplink direction and by transmitting a second communication to a second UE in a downlink direction, and wherein the CLI measurement is associated with the first communication.

In a second aspect, alone or in combination with the first aspect, the base station is operating in a half duplex mode, and wherein the CLI measurement is associated an uplink communication received by the base station from a UE.

In a third aspect, alone or in combination with one or more of the first and second aspects, process 700 includes performing at least one of a received signal strength indicator measurement based at least in part on the reference signal or a reference signal received power measurement based at least in part on the reference signal.

In a fourth aspect, alone or in combination with one or more of the first through third aspects, process 700 includes detecting an arrival time of the reference signal at the base station, wherein the adjustment of the scheduled uplink reception period is based at least in part on detecting the arrival time of the reference signal.

In a fifth aspect, alone or in combination with one or more of the first through fourth aspects, process 700 includes receiving, in the first time resource and from a third base station, another reference signal, wherein the reference signal and the other reference signal are at least one of frequency division multiplexed or code division multiplexed, and detecting an arrival time of the other reference signal at the base station, wherein the adjustment of the scheduled uplink reception period is based at least in part on detecting the arrival time of the other reference signal.

In a sixth aspect, alone or in combination with one or more of the first through fifth aspects, the reference signal is one of an SSB signal, a PRACH signal, or an RIM-RS.

In a seventh aspect, alone or in combination with one or more of the first through sixth aspects, process 700 includes receiving an indication of the scheduled downlink transmission period associated with the other base station, wherein the adjustment of the scheduled uplink reception period is based at least in part on the indication of the scheduled downlink transmission period.

In an eighth aspect, alone or in combination with one or more of the first through seventh aspects, the reference signal is one of an SSB signal, a CSI-RS, an SRS, a PRACH signal, or an RIM-RS.

In a ninth aspect, alone or in combination with one or more of the first through eighth aspects, a difference between a time at which the first time resource begins and a time at which the reference signal arrives at the base station is less than a duration of a cyclic prefix of a symbol of the first time resource.

In a tenth aspect, alone or in combination with one or more of the first through ninth aspects, a difference between a time at which the first time resource begins and a time at which the reference signal arrives at the base station is less than a duration of a threshold number of symbols of the first time resource.

In an eleventh aspect, alone or in combination with one or more of the first through tenth aspects, process 700 includes receiving a configuration of the first time resource.

In a twelfth aspect, alone or in combination with one or more of the first through eleventh aspects, the configuration is received from one of an OAM node, an LMF node, a gNB-CU node, or a gNB-DU node.

In a thirteenth aspect, alone or in combination with one or more of the first through twelfth aspects, at least one of the first time resource or the second time resource is defined in a wireless communication specification.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with inter-base-station interference reference signal transmission and reception timing.

As shown in FIG. 8, in some aspects, process 800 may include receiving, in a first time resource and from another base station, a reference signal associated with a second time resource, wherein the first time resource is based at least in part a scheduled uplink reception period associated with the base station, and wherein the second time resource is based at least in part on an adjustment of a scheduled downlink transmission period associated with the other base station such that the reference signal associated with the second time resource is received by the base station within the first time resource (block 810). For example, the base station (e.g., using communication manager 150 and/or reception component 1002, depicted in FIG. 10) may receive, in a first time resource and from another base station, a reference signal associated with a second time resource, wherein the first time resource is based at least in part a scheduled uplink reception period associated with the base station, and wherein the second time resource is based at least in part on an adjustment of a scheduled downlink transmission period associated with the other base station such that the reference signal associated with the second time resource is received by the base station within the first time resource, as described above.

As further shown in FIG. 8, in some aspects, process 800 may include performing a CLI measurement using the reference signal (block 820). For example, the base station (e.g., using communication manager 150 and/or measurement component 1008, depicted in FIG. 10) may perform a CLI measurement using the reference signal, as described above.

Process 800 may include additional aspects, such as any single aspect or any combination of aspects described below and/or in connection with one or more other processes described elsewhere herein.

In a first aspect, the base station is operating in a full duplex mode by receiving a first communication from a first UE in an uplink direction and by transmitting a second communication to a second UE in a downlink direction, and wherein the CLI measurement is associated with the first communication.

In a second aspect, alone or in combination with the first aspect, the base station is operating in a half duplex mode, and wherein the CLI measurement is associated an uplink communication received by the base station from a UE.

In a third aspect, alone or in combination with one or more of the first and second aspects, process 800 includes performing at least one of a received signal strength indicator measurement based at least in part on the reference signal or a reference signal received power measurement based at least in part on the reference signal.

In a fourth aspect, alone or in combination with one or more of the first through third aspects, process 800 includes transmitting, to the other base station, an indication of the scheduled uplink reception period associated with the base station, wherein the adjustment of the scheduled downlink transmission period is based at least in part on the indication of the scheduled uplink reception period.

In a fifth aspect, alone or in combination with one or more of the first through fourth aspects, the reference signal is one of an SSB signal, a CSI-RS, an SRS, a PRACH signal, or an RIM-RS.

In a sixth aspect, alone or in combination with one or more of the first through fifth aspects, a difference between a time at which the first time resource begins and a time at which the reference signal arrives at the base station is less than a duration of a cyclic prefix of a symbol of the first time resource.

In a seventh aspect, alone or in combination with one or more of the first through sixth aspects, a difference between a time at which the first time resource begins and a time at which the reference signal arrives at the base station is less than a duration of a threshold number of symbols of the first time resource.

In an eighth aspect, alone or in combination with one or more of the first through seventh aspects, process 800 includes receiving, from a third base station, another reference signal, wherein the other reference signal is associated with a third time resource, and wherein the reference signal and the other reference signal are at least one of frequency division multiplexed or code division multiplexed.

In a ninth aspect, alone or in combination with one or more of the first through eighth aspects, process 800 includes receiving a configuration of the first time resource.

In a tenth aspect, alone or in combination with one or more of the first through ninth aspects, the configuration is received from one of an OAM node, an LMF node, a gNB-CU node, or a gNB-DU node.

In an eleventh aspect, alone or in combination with one or more of the first through tenth aspects, at least one of the first time resource or the second time resource is defined in a wireless communication specification.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with inter-base-station interference reference signal transmission and reception timing.

As shown in FIG. 9, in some aspects, process 900 may include receiving, in a first time resource and from another base station, a reference signal associated with a second time resource, wherein the first time resource is based at least in part on a scheduled uplink reception period associated with the base station, and wherein the second time resource is based at least in part on a scheduled downlink transmission period associated with the other base station (block 910). For example, the base station (e.g., using communication manager 150 and/or reception component 1002, depicted in FIG. 10) may receive, in a first time resource and from another base station, a reference signal associated with a second time resource, wherein the first time resource is based at least in part on a scheduled uplink reception period associated with the base station, and wherein the second time resource is based at least in part on a scheduled downlink transmission period associated with the other base station, as described above.

As further shown in FIG. 9, in some aspects, process 900 may include performing a CLI measurement using the reference signal (block 920). For example, the base station (e.g., using communication manager 150 and/or measurement component 1008, depicted in FIG. 10) may perform a CLI measurement using the reference signal, as described above.

Process 900 may include additional aspects, such as any single aspect or any combination of aspects described below and/or in connection with one or more other processes described elsewhere herein.

In a first aspect, the base station is operating in a full duplex mode by receiving a first communication from a first UE in an uplink direction and by transmitting a second communication to a second UE in a downlink direction, and wherein the CLI measurement is associated with the first communication.

In a second aspect, alone or in combination with the first aspect, the base station is operating in a half duplex mode, and wherein the CLI measurement is associated an uplink communication received by the base station from a UE.

In a third aspect, alone or in combination with one or more of the first and second aspects, process 900 includes performing a received signal strength indicator measurement based at least in part on the reference signal.

In a fourth aspect, alone or in combination with one or more of the first through third aspects, process 900 includes receiving, in the first time resource and from a third base station, another reference signal, wherein the reference signal and the other reference signal are frequency division multiplexed.

In a fifth aspect, alone or in combination with one or more of the first through fourth aspects, the reference signal is one of an SSB signal, a CSI-RS, an SRS, a PRACH signal, or an RIM-RS.

In a sixth aspect, alone or in combination with one or more of the first through fifth aspects, at least one of the first time resource or the second time resource is defined in a wireless communication specification.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include one or more of a measurement component 1008, or a detection component 1010, among other examples.

In some aspects, the apparatus 1000 may be configured to perform one or more operations described herein in connection with FIGS. 5-6D. Additionally, or alternatively, the apparatus 1000 may be configured to perform one or more processes described herein, such as process 700 of FIG. 7, process 800 of FIG. 8, process 900 of FIG. 9, or a combination thereof. In some aspects, the apparatus 1000 and/or one or more components shown in FIG. 10 may include one or more components of the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the base station described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the base station described in connection with FIG. 2. In some aspects, the transmission component 1004 may be co-located with the reception component 1002 in a transceiver.

The reception component 1002 may receive, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource. The measurement component 1008 may perform a CLI measurement using the reference signal.

The measurement component 1008 may perform at least one of a received signal strength indicator measurement based at least in part on the reference signal or a reference signal received power measurement based at least in part on the reference signal.

The detection component 1010 may detect an arrival time of the reference signal at the base station, wherein the adjustment of the scheduled uplink reception period is based at least in part on detecting the arrival time of the reference signal.

The reception component 1002 may receive, in the first time resource and from a third base station, another reference signal, wherein the reference signal and the other reference signal are at least one of frequency division multiplexed or code division multiplexed.

The detection component 1010 may detect an arrival time of the other reference signal at the base station, wherein the adjustment of the scheduled uplink reception period is based at least in part on detecting the arrival time of the other reference signal.

The reception component 1002 may receive an indication of the scheduled downlink transmission period associated with the other base station, wherein the adjustment of the scheduled uplink reception period is based at least in part on the indication of the scheduled downlink transmission period.

The reception component 1002 may receive a configuration of the first time resource.

The reception component 1002 may receive, in a first time resource and from another base station, a reference signal associated with a second time resource, wherein the first time resource is based at least in part a scheduled uplink reception period associated with the base station, and wherein the second time resource is based at least in part on an adjustment of a scheduled downlink transmission period associated with the other base station such that the reference signal associated with the second time resource is received by the base station within the first time resource. The measurement component 1008 may perform a CLI measurement using the reference signal.

The measurement component 1008 may perform at least one of a received signal strength indicator measurement based at least in part on the reference signal or a reference signal received power measurement based at least in part on the reference signal.

The transmission component 1004 may transmit, to the other base station, an indication of the scheduled uplink reception period associated with the base station, wherein the adjustment of the scheduled downlink transmission period is based at least in part on the indication of the scheduled uplink reception period.

The reception component 1002 may receive, from a third base station, another reference signal, wherein the other reference signal is associated with a third time resource, and wherein the reference signal and the other reference signal are at least one of frequency division multiplexed or code division multiplexed.

The reception component 1002 may receive a configuration of the first time resource.

The reception component 1002 may receive, in a first time resource and from another base station, a reference signal associated with a second time resource, wherein the first time resource is based at least in part on a scheduled uplink reception period associated with the base station, and wherein the second time resource is based at least in part on a scheduled downlink transmission period associated with the other base station. The measurement component 1008 may perform a CLI measurement using the reference signal.

The measurement component 1008 may perform a received signal strength indicator measurement based at least in part on the reference signal.

The reception component 1002 may receive, in the first time resource and from a third base station, another reference signal, wherein the reference signal and the other reference signal are frequency division multiplexed.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a base station, comprising: receiving, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource; and performing a CLI measurement using the reference signal.

Aspect 2: The method of Aspect 1, wherein the base station is operating in a full duplex mode by receiving a first communication from a first UE in an uplink direction and by transmitting a second communication to a second UE in a downlink direction, and wherein the CLI measurement is associated with the first communication.

Aspect 3: The method of Aspect 1, wherein the base station is operating in a half duplex mode, and wherein the CLI measurement is associated an uplink communication received by the base station from a UE.

Aspect 4: The method of any of Aspects 1-3, further comprising performing at least one of a received signal strength indicator measurement based at least in part on the reference signal or a reference signal received power measurement based at least in part on the reference signal.

Aspect 5: The method of any of Aspects 1-4, further comprising detecting an arrival time of the reference signal at the base station, wherein the adjustment of the scheduled uplink reception period is based at least in part on detecting the arrival time of the reference signal.

Aspect 6: The method of Aspect 5, further comprising: receiving, in the first time resource and from a third base station, another reference signal, wherein the reference signal and the other reference signal are at least one of frequency division multiplexed or code division multiplexed; and detecting an arrival time of the other reference signal at the base station, wherein the adjustment of the scheduled uplink reception period is based at least in part on detecting the arrival time of the other reference signal.

Aspect 7: The method of Aspect 5, wherein the reference signal is one of an SSB signal, a PRACH signal, or an RIM-RS.

Aspect 8: The method of any of Aspects 1-7, further comprising receiving an indication of the scheduled downlink transmission period associated with the other base station, wherein the adjustment of the scheduled uplink reception period is based at least in part on the indication of the scheduled downlink transmission period.

Aspect 9: The method of Aspect 8, wherein the reference signal is one of an SSB signal, a CSI-RS, an SRS, a PRACH signal, or an RIM-RS.

Aspect 10: The method of Aspect 8, wherein a difference between a time at which the first time resource begins and a time at which the reference signal arrives at the base station is less than a duration of a cyclic prefix of a symbol of the first time resource.

Aspect 11: The method of Aspect 8, wherein a difference between a time at which the first time resource begins and a time at which the reference signal arrives at the base station is less than a duration of a threshold number of symbols of the first time resource.

Aspect 12: The method of any of Aspects 1-11, further comprising receiving a configuration of the first time resource.

Aspect 13: The method of Aspect 12, wherein the configuration is received from one of an OAM node, an LMF node, a gNB-CU node, or a gNB-DU node.

Aspect 14: The method of any of Aspects 1-13, wherein at least one of the first time resource or the second time resource is defined in a wireless communication specification.

Aspect 15: A method of wireless communication performed by a base station, comprising: receiving, in a first time resource and from another base station, a reference signal associated with a second time resource, wherein the first time resource is based at least in part a scheduled uplink reception period associated with the base station, and wherein the second time resource is based at least in part on an adjustment of a scheduled downlink transmission period associated with the other base station such that the reference signal associated with the second time resource is received by the base station within the first time resource; and performing a CLI measurement using the reference signal.

Aspect 16: The method of Aspect 15, wherein the base station is operating in a full duplex mode by receiving a first communication from a first UE in an uplink direction and by transmitting a second communication to a second UE in a downlink direction, and wherein the CLI measurement is associated with the first communication.

Aspect 17: The method of Aspect 15, wherein the base station is operating in a half duplex mode, and wherein the CLI measurement is associated an uplink communication received by the base station from a UE.

Aspect 18: The method of any of Aspects 15-17, further comprising performing at least one of a received signal strength indicator measurement based at least in part on the reference signal or a reference signal received power measurement based at least in part on the reference signal.

Aspect 19: The method of any of Aspects 15-18, further comprising transmitting, to the other base station, an indication of the scheduled uplink reception period associated with the base station, wherein the adjustment of the scheduled downlink transmission period is based at least in part on the indication of the scheduled uplink reception period.

Aspect 20: The method of any of Aspects 15-19, wherein the reference signal is one of an SSB signal, a CSI-RS, an SRS, a PRACH signal, or an RIM-RS.

Aspect 21: The method of any of Aspects 15-20, wherein a difference between a time at which the first time resource begins and a time at which the reference signal arrives at the base station is less than a duration of a cyclic prefix of a symbol of the first time resource.

Aspect 22: The method of any of Aspects 15-21, wherein a difference between a time at which the first time resource begins and a time at which the reference signal arrives at the base station is less than a duration of a threshold number of symbols of the first time resource.

Aspect 23: The method of any of Aspects 15-22, further comprising receiving, from a third base station, another reference signal, wherein the other reference signal is associated with a third time resource, and wherein the reference signal and the other reference signal are at least one of frequency division multiplexed or code division multiplexed.

Aspect 24: The method of any of Aspects 15-23, further comprising receiving a configuration of the first time resource.

Aspect 25: The method of Aspect 24, wherein the configuration is received from one of an OAM node, an LMF node, a gNB-CU node, or a gNB-DU node.

Aspect 26: The method of any of Aspects 15-25, wherein at least one of the first time resource or the second time resource is defined in a wireless communication specification.

Aspect 27: A method of wireless communication performed by a base station, comprising: receiving, in a first time resource and from another base station, a reference signal associated with a second time resource, wherein the first time resource is based at least in part on a scheduled uplink reception period associated with the base station, and wherein the second time resource is based at least in part on a scheduled downlink transmission period associated with the other base station; and performing a CLI measurement using the reference signal.

Aspect 28: The method of Aspect 27, wherein the base station is operating in a full duplex mode by receiving a first communication from a first UE in an uplink direction and by transmitting a second communication to a second UE in a downlink direction, and wherein the CLI measurement is associated with the first communication.

Aspect 29: The method of Aspect 27, wherein the base station is operating in a half duplex mode, and wherein the CLI measurement is associated an uplink communication received by the base station from a UE.

Aspect 30: The method of any of Aspects 27-29, further comprising performing a received signal strength indicator measurement based at least in part on the reference signal.

Aspect 31: The method of any of Aspects 27-30, further comprising receiving, in the first time resource and from a third base station, another reference signal, wherein the reference signal and the other reference signal are frequency division multiplexed.

Aspect 32: The method of any of Aspects 27-31, wherein the reference signal is one of an SSB signal, a CSI-RS, an SRS, a PRACH signal, or an RIM-RS.

Aspect 33: The method of any of Aspects 27-32, wherein at least one of the first time resource or the second time resource is defined in a wireless communication specification.

Aspect 34: An apparatus for wireless communication at a device, comprising a processor; memory coupled with the processor; and instructions stored in the memory and executable by the processor to cause the apparatus to perform the method of one or more of Aspects 1-14.

Aspect 35: A device for wireless communication, comprising a memory and one or more processors coupled to the memory, the one or more processors configured to perform the method of one or more of Aspects 1-14.

Aspect 36: An apparatus for wireless communication, comprising at least one means for performing the method of one or more of Aspects 1-14.

Aspect 37: A non-transitory computer-readable medium storing code for wireless communication, the code comprising instructions executable by a processor to perform the method of one or more of Aspects 1-14.

Aspect 38: A non-transitory computer-readable medium storing a set of instructions for wireless communication, the set of instructions comprising one or more instructions that, when executed by one or more processors of a device, cause the device to perform the method of one or more of Aspects 1-14.

Aspect 39: An apparatus for wireless communication at a device, comprising a processor; memory coupled with the processor; and instructions stored in the memory and executable by the processor to cause the apparatus to perform the method of one or more of Aspects 15-26.

Aspect 40: A device for wireless communication, comprising a memory and one or more processors coupled to the memory, the one or more processors configured to perform the method of one or more of Aspects 15-26.

Aspect 41: An apparatus for wireless communication, comprising at least one means for performing the method of one or more of Aspects 15-26.

Aspect 42: A non-transitory computer-readable medium storing code for wireless communication, the code comprising instructions executable by a processor to perform the method of one or more of Aspects 15-26.

Aspect 43: A non-transitory computer-readable medium storing a set of instructions for wireless communication, the set of instructions comprising one or more instructions that, when executed by one or more processors of a device, cause the device to perform the method of one or more of Aspects 15-26.

Aspect 44: An apparatus for wireless communication at a device, comprising a processor; memory coupled with the processor; and instructions stored in the memory and executable by the processor to cause the apparatus to perform the method of one or more of Aspects 27-33.

Aspect 45: A device for wireless communication, comprising a memory and one or more processors coupled to the memory, the one or more processors configured to perform the method of one or more of Aspects 27-33.

Aspect 46: An apparatus for wireless communication, comprising at least one means for performing the method of one or more of Aspects 27-33.

Aspect 47: A non-transitory computer-readable medium storing code for wireless communication, the code comprising instructions executable by a processor to perform the method of one or more of Aspects 27-33.

Aspect 48: A non-transitory computer-readable medium storing a set of instructions for wireless communication, the set of instructions comprising one or more instructions that, when executed by one or more processors of a device, cause the device to perform the method of one or more of Aspects 27-33.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a base station, comprising:
a memory; and
one or more processors, coupled to the memory, configured to:
receive, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource; and
perform a crosslink interference (CLI) measurement using the reference signal.

2. The apparatus of claim 1, wherein the base station is operating in a full duplex mode by receiving a first communication from a first user equipment (UE) in an uplink direction and by transmitting a second communication to a second UE in a downlink direction, and wherein the CLI measurement is associated with the first communication.

3. The apparatus of claim 1, wherein the base station is operating in a half duplex mode, and wherein the CLI measurement is associated an uplink communication received by the base station from a user equipment (UE).

4. The apparatus of claim 1, wherein the one or more processors are further configured to perform at least one of a received signal strength indicator measurement based at least in part on the reference signal or a reference signal received power measurement based at least in part on the reference signal.

5. The apparatus of claim 1, wherein the one or more processors are further configured to detect an arrival time of the reference signal at the base station, wherein the adjustment of the scheduled uplink reception period is based at least in part on detecting the arrival time of the reference signal.

6. The apparatus of claim 5, wherein the one or more processors are further configured to:
receive, in the first time resource and from a third base station, another reference signal, wherein the reference signal and the other reference signal are at least one of frequency division multiplexed or code division multiplexed; and
detect an arrival time of the other reference signal at the base station, wherein the adjustment of the scheduled uplink reception period is based at least in part on detecting the arrival time of the other reference signal.

7. The apparatus of claim 5, wherein the reference signal is one of a synchronization signal block (SSB) signal, a physical random access channel (PRACH) signal, or a remote interference management reference signal (RIM-RS).

8. The apparatus of claim 1, wherein the one or more processors are further configured to receive an indication of the scheduled downlink transmission period associated with the other base station, wherein the adjustment of the scheduled uplink reception period is based at least in part on the indication of the scheduled downlink transmission period.

9. The apparatus of claim 8, wherein the reference signal is one of a synchronization signal block (SSB) signal, a channel station information reference signal (CSI-RS), a sounding reference signal (SRS), a physical random access channel (PRACH) signal, or a remote interference management reference signal (RIM-RS).

10. The apparatus of claim 8, wherein a difference between a time at which the first time resource begins and a time at which the reference signal arrives at the base station is less than a duration of a cyclic prefix of a symbol of the first time resource.

11. The apparatus of claim 8, wherein a difference between a time at which the first time resource begins and a time at which the reference signal arrives at the base station is less than a duration of a threshold number of symbols of the first time resource.

12. The apparatus of claim 1, wherein the one or more processors are further configured to receive a configuration of the first time resource.

13. The apparatus of claim 12, wherein the configuration is received from one of an operation and management (OAM) node, a location management function (LMF) node, a gNodeB (gNB) central unit (gNB-CU) node, or a gNB distributed unit (gNB-DU) node.

14. The apparatus of claim 1, wherein at least one of the first time resource or the second time resource is defined in a wireless communication specification.

15. An apparatus for wireless communication at a base station, comprising:
a memory; and
one or more processors, coupled to the memory, configured to:
receive, in a first time resource and from another base station, a reference signal associated with a second time resource, wherein the first time resource is based at least in part a scheduled uplink reception period associated with the base station, and wherein the second time resource is based at least in part on an adjustment of a scheduled downlink transmission period associated with the other base station such that the reference signal associated with the second time resource is received by the base station within the first time resource; and
perform a crosslink interference (CLI) measurement using the reference signal.

16. The apparatus of claim 15, wherein the base station is operating in a full duplex mode by receiving a first communication from a first user equipment (UE) in an uplink direction and by transmitting a second communication to a second UE in a downlink direction, and wherein the CLI measurement is associated with the first communication.

17. The apparatus of claim 15, wherein the base station is operating in a half duplex mode, and wherein the CLI measurement is associated an uplink communication received by the base station from a user equipment (UE).

18. The apparatus of claim 15, wherein the one or more processors are further configured to perform at least one of a received signal strength indicator measurement based at least in part on the reference signal or a reference signal received power measurement based at least in part on the reference signal.

19. The apparatus of claim 15, wherein the one or more processors are further configured to transmit, to the other base station, an indication of the scheduled uplink reception period associated with the base station, wherein the adjustment of the scheduled downlink transmission period is based at least in part on the indication of the scheduled uplink reception period.

20. The apparatus of claim 15, wherein the reference signal is one of a synchronization signal block (SSB) signal, a channel station information reference signal (CSI-RS), a sounding reference signal (SRS), a physical random access channel (PRACH) signal, or a remote interference management reference signal (RIM-RS).

21. The apparatus of claim 15, wherein a difference between a time at which the first time resource begins and a time at which the reference signal arrives at the base station is less than a duration of a cyclic prefix of a symbol of the first time resource.

22. The apparatus of claim 15, wherein a difference between a time at which the first time resource begins and a time at which the reference signal arrives at the base station is less than a duration of a threshold number of symbols of the first time resource.

23. The apparatus of claim 15, wherein the one or more processors are further configured to receive, from a third base station, another reference signal, wherein the other reference signal is associated with a third time resource, and wherein the reference signal and the other reference signal are at least one of frequency division multiplexed or code division multiplexed.

24. The apparatus of claim 15, wherein the one or more processors are further configured to receive a configuration of the first time resource from one of an operation and management (OAM) node, a location management function (LMF) node, a gNodeB (gNB) central unit (gNB-CU) node, or a gNB distributed unit (gNB-DU) node.

25. The apparatus of claim 15, wherein at least one of the first time resource or the second time resource is defined in a wireless communication specification.

26. An apparatus for wireless communication at a base station, comprising:
a memory; and
one or more processors, coupled to the memory, configured to:
receive, in a first time resource and from another base station, a reference signal associated with a second time resource, wherein the first time resource is based at least in part on a scheduled uplink reception period associated with the base station, and wherein the second time resource is based at least in part on a scheduled downlink transmission period associated with the other base station; and
perform a crosslink interference (CLI) measurement using the reference signal.

27. The apparatus of claim 26, wherein the base station is operating in a full duplex mode by receiving a first communication from a first user equipment (UE) in an uplink direction and by transmitting a second communication to a second UE in a downlink direction, and wherein the CLI measurement is associated with the first communication.

28. The apparatus of claim 26, wherein the base station is operating in a half duplex mode, and wherein the CLI measurement is associated an uplink communication received by the base station from a user equipment (UE).

29. A method of wireless communication performed by a base station, comprising:
receiving, in a first time resource and from another base station, a reference signal associated with a second time resource, wherein the second time resource is based at least in part on a scheduled downlink transmission period associated with the other base station, and wherein the first time resource is based at least in part on an adjustment of a scheduled uplink reception period associated with the base station such that the reference signal associated with the second time resource is received by the base station within the first time resource; and
performing a crosslink interference (CLI) measurement using the reference signal.

30. The method of claim 29, wherein the base station is operating in a full duplex mode by receiving a first communication from a first user equipment (UE) in an uplink direction and by transmitting a second communication to a second UE in a downlink direction, and wherein the CLI measurement is associated with the first communication.
